(19) United States
(12) Patent Application Publication
(10) Pub. No.: US 2017/0094617 A1
(43) Pub. Date: Mar. 30, 2017

(54) SMALL CELL SYNCHRONIZATION

(71) Applicant: Verizon Patent and Licensing Inc., Arlington, VA (US)

(72) Inventor: Ram Gopal Lakshmi Narayanan, Pleasanton, CA (US)

(21) Appl. No.: 14/868,508

(22) Filed: Sep. 29, 2015

(51) Int. Cl. H04W 56/00; H04W 72/04; H04W 76/02

(52) U.S. Cl. CPC H04W 56/00; H04W 76/023; H04W 72/0406

(57) ABSTRACT

Techniques described herein may be used to distribute timing information to small cell devices. For example, in response to powering on, a small cell device may automatically receive timing information from a base station of a wireless telecommunications network. The small cell device may use the timing information to set an internal clock of the small cell device. The small cell device may automatically connect to other small cell devices via a device-to-device (D2D) connection, and may communicate the timing information to the other small cell devices.

### BACKGROUND

The use of wireless networks, to support mobile data communications, continues to grow rapidly. One trend in the implementation of cellular wireless networks is the increasing reliance on heterogeneous networks (HetNets). A heterogeneous cellular network may include traditional macrocell base stations overlaid with small cells (femtocells, picocells, wireless relays, etc.). The small cells may include, relative to the macrocells, smaller form factor and lower power radio nodes. By deploying HetNets with targeted small cell installations, network operators can offload users from macrocells to small cells. This technique may be particularly useful in areas with poor radio reception and/or dense mobile device populations.

As mentioned, small cell device may include a low-powered radio access node that has a smaller coverage area than a base stations, such as an enhanced Node B (eNB). In order for the small cell to operate properly each small cell device may require timing information to synchronize an internal clock of the small cell device with the internal clocks of the other small cell devices in a deployment. Without proper timing information, the small cell devices may not be able to send and receive information to user devices connected via the small cell devices, features like handovers may not work, small cell devices may not be able to connect to one another, small cell devices may not be capable of passing security checks, etc. As such, timing and synchronization may be central to a functional of wireless infrastructure.

Currently available solutions for providing timing information to small cell devices include connecting the small cell devices to another device capable of receiving timing information from another network, and distributing timing information to the small cell devices. For example, a deployment of small cell devices may be connected to a server device that may receive timing information via a global position system (GPS) and that may distribute the timing information to the small cell devices (often via a network of switches). In another example, small cell devices may be connected to a Timing over Packet (ToP) or Timing over Packet Synchronization (ToPSync) server that may receive timing information from an external network (e.g., the Internet) and that may distribute the timing information to the small cell devices via a network of switches.

### BRIEF DESCRIPTION OF THE DRAWINGS

Embodiments of the present invention will be readily understood by the following detailed description in conjunction with the accompanying drawings. To facilitate this description, like reference numerals may designate like structural elements. Embodiments are illustrated by way of example and not by way of limitation in the figures of the accompanying drawings.

FIGS. 1A-1D illustrate an example overview of an implementation described herein;

FIG. 2 is a diagram of an example environment in which systems and/or methods described herein may be implemented;

FIG. 3 is a diagram of an example of components of a small cell device;

FIG. 4 is a flowchart diagram of an example process for synchronizing an internal clock of a small cell device;

FIG. 5 is a sequence flow diagram of an example implementation for synchronizing an internal clock of small cell device;

FIGS. 6 and 7 are diagrams of example implementations for establishing a connection between a small cell device and an enhanced Node B (eNB);

FIG. 8 is a flowchart diagram of another example process for synchronizing an internal clock of a small cell device; and

FIG. 9 is a diagram of example components of a device.

### DETAILED DESCRIPTION OF PREFERRED EMBODIMENTS

The following detailed description refers to the accompanying drawings. The same reference numbers in different drawings may identify the same or similar elements. It is to be understood that other embodiments may be utilized and structural or logical changes may be made without departing from the scope of the present disclosure. Therefore, the following detailed description is not to be taken in a limiting sense, and the scope of embodiments in accordance with the present invention is defined by the appended claims and their equivalents.

Techniques described herein may be used to synchronize small cell devices without requiring other network devices, such as servers and switches. For example, a small cell device may include a wireless network interface capable of passively receiving information from a base station, such as an enhanced Node B (eNB), of a wireless telecommunications network. As such, in response to powering on, the small cell device may listen for a signal from an eNB that includes timing information. The small cell device may use the timing information to set an internal clock of the small cell device.

The small cell device may also include the capability of establishing device-to-device (D2D) connection with other small cell devices. For instance, the small cell device may discover other small cell devices within the vicinity. Upon discovering another small cell device, the small cell device may automatically establish a D2D connection with the other small cell device and may communicate timing information to the other small cell device so that the small cell devices may become synchronized with one another. As such, techniques described herein may enable small cell devices to become synchronized with one another without requiring other network devices such as servers and switches.

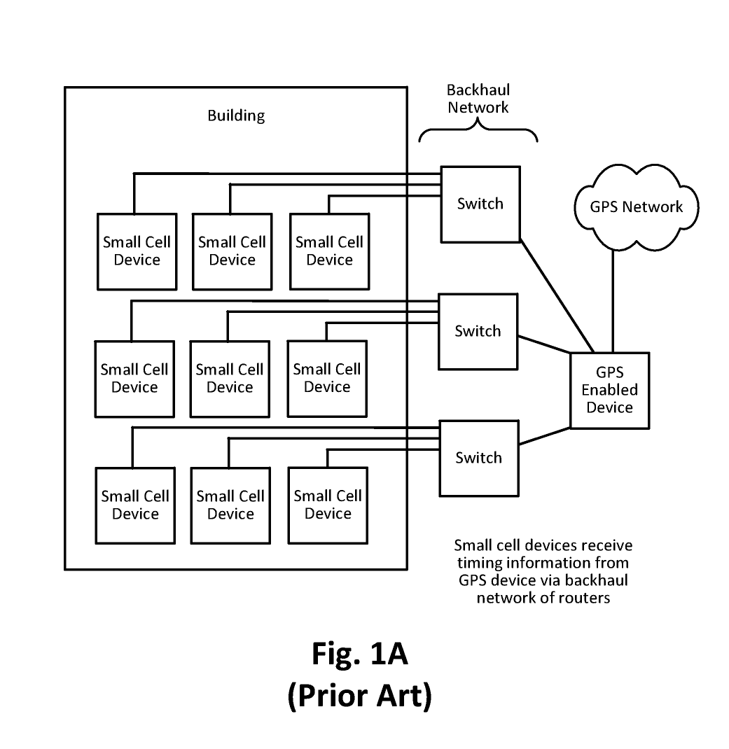

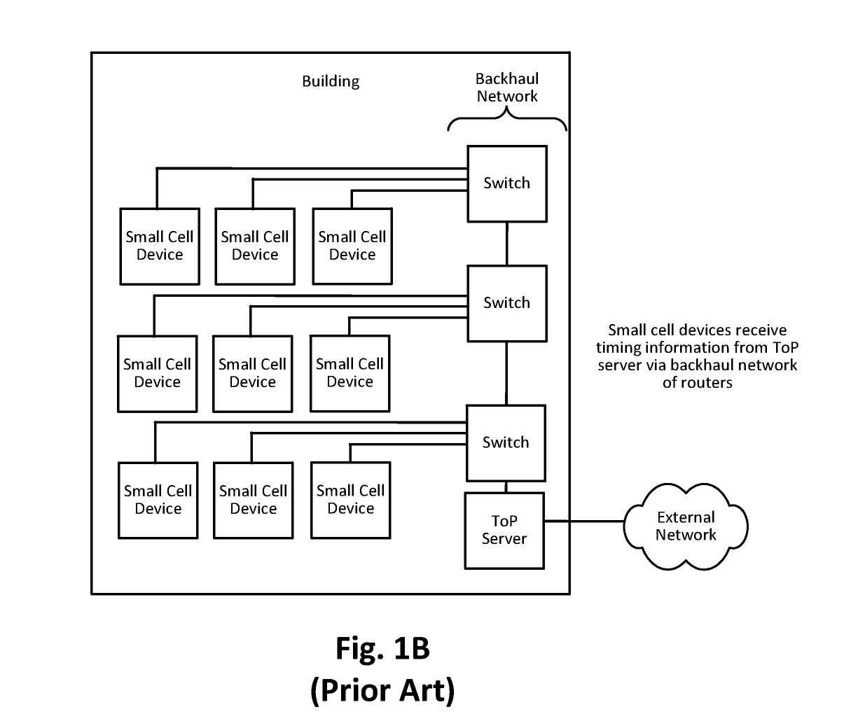

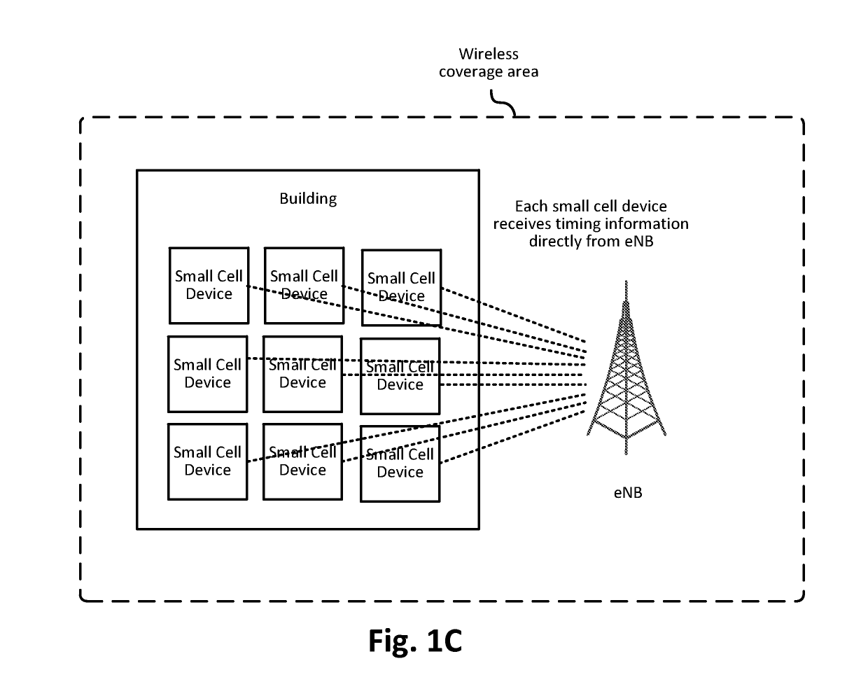

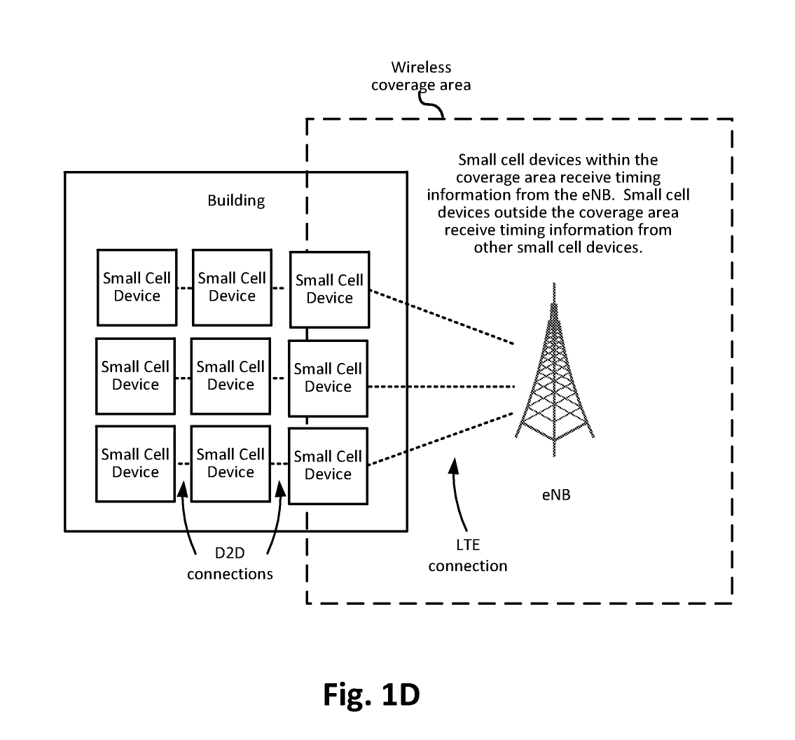

FIGS. 1A-1D illustrate an example overview of an implementation described herein. More particularly, FIGS. 1A and 1B provide examples of small cell deployment configurations that are known. By contrast, FIGS. 1C and 1D provide examples of small cell deployment configurations in accordance techniques described herein.

As shown in FIG. 1A, a building may include multiple small cell devices. The small cell devices may be connected to a network of switches that may, in turn, be connected to a global positioning system (GPS) enabled device capable of communicating with a GPS network. The GPS enabled device may receive timing information from the GPS network and may communicate the timing information to the small cell devices via the network of switches. The small cell devices may use the timing information for synchronization purposes. As such, FIG. 1A provides an example of a deployment of small cell device where small cell devices require additional devices g (e.g., switches and a GPS enabled device) and cabling order to receive timing information and become synchronized.

Similarly, in the example of FIG. 1B, a building may include a deployment of small cell device that includes multiple small cell devices. The small cell devices may be connected to a network of switches that may, in turn, be connected to a Timing over Packet (ToP) server. The ToP server may be connected to an external network that may provide timing information to the ToP server. The ToP server may communicate the timing information to the small cell devices via the network of switches to enable the small cell devices to synchronize. As such, FIG. 1B provides another example of a deployment of small cell device where small cell devices require additional devices (e.g., a network of switches and a ToP server) and cabling in order to receive timing information and become synchronized.

In the example of FIG. 1C, a building may include multiple small cell devices. The small cell devices may be within the coverage area of an eNB of a wireless telecommunications network. The small cell devices may automatically receive timing information that is broadcasted by the eNB and may become synchronized with one another by setting an internal clock of each small cell device according to the timing information from the eNB. The small cell devices may also discover, and connect to, one another by broadcasting a device discovery signal and establishing a connection (e.g., a D2D connection) with other small cell devices in the building.

In the example of FIG. 1D, some of the small cell devices in the building may be out of the coverage area of the eNB. In such a scenario, the small cell devices within the coverage area may automatically receive the timing information that is broadcasted by the eNB and may set an internal clock according to the timing information in order to become synchronized with one another. The synchronized small cell devices may also communicate device discovery signals in search for other small cell devices (e.g., in the building). Upon discovering another small cell device, one of the synchronized small cell devices may establish a D2D connection with the newly discovered small cell device and provide the new small cell device timing information that may be used by the new small cell device to become synchronized. The new small cell device may, in turn, broadcast a device discovery signal in order to discover and become synchronized with other small cell devices in the vicinity. As such, FIG. 1C provides an example where small cell devices do not require additional devices (other than eNB) in order to receive timing information and become synchronized with one another.

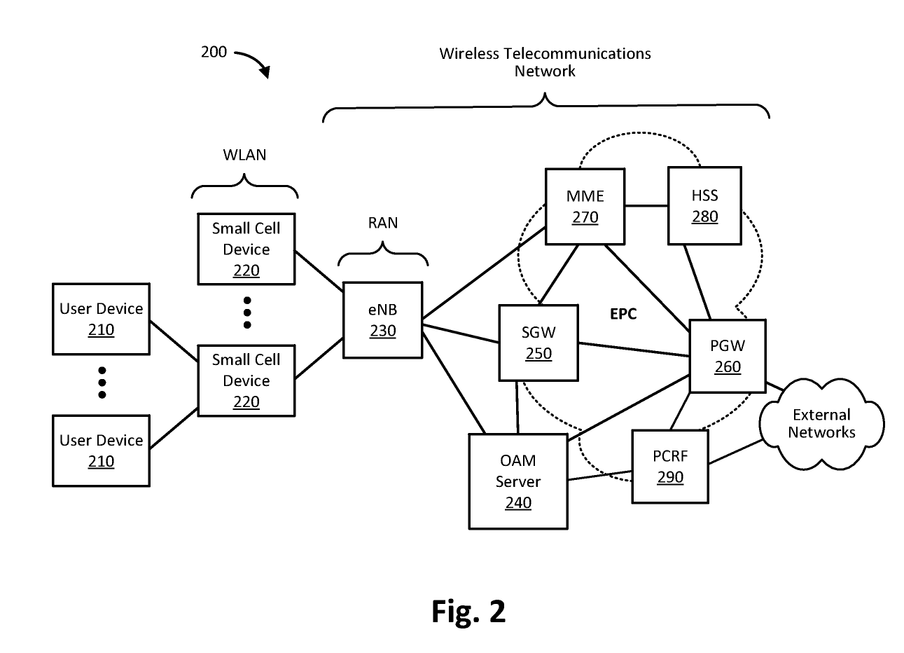

FIG. 2 is a diagram of an example environment 200 in which systems and/or methods described herein may be implemented. Environment 200 may include user devices 210, small cell devices 220, a wireless telecommunications network, and external networks. The wireless telecommunications network may include an Evolved Packet System (EPS) that includes a Longer Term Evolution (LTE) network and/or an evolved packet core (EPC) network that operates based on a 3rd Generation Partnership Project (3GPP) wireless communication standard. The LTE network may be, or may include, a RAN that include one or more base stations, some or all of which may take the form of eNBs 230, via which user devices 210 may communicate with the EPC network. The wireless telecommunications network may also include an operations, administration, and management (OAM or O&AM) server 240.

The EPC network may include Serving Gateway (SGW) 250, PDN Gateway (PGW) 260, Mobility Management Entity (MME) 270, Home Subscriber Server (HSS) 280, and/or Policy and Charging Rules Function (PCRF) 290. As shown, the EPC network may enable user devices 210 to communicate with an external network, such as a Public Land Mobile Networks (PLMN), a Public Switched Telephone Network (PSTN), and/or an Internet Protocol (IP) network (e.g., the Internet).

User device 210 may include a portable computing and communication devices, such as a personal digital assistant (PDA), a smart phone, a cellular phone, a laptop computer with connectivity to the wireless telecommunications network, a tablet computer, etc. User device 210 may also include a non-portable computing device, such as a desktop computer, a consumer or business appliance, or another device that has the ability to connect to a RAN of the wireless telecommunications network. User device 210 may be capable of establishing a connection small cell device 220 for access to the wireless communications network.

Small cell device 220 may include a wireless a low-powered radio access node that provide user devices 210 with access to the WLAN. In some implementations, small cell device 220 may also provide user devices 210 with access to the wireless telecommunications network. In some implementations, small cell device 220 may also, or alternatively, provide user device 210 with access to another network, such as the Internet. Small cell device 220 may passively receive timing information that is periodically broadcasted by eNB 230. Small cell device 230 may use the timing information to synchronize become synchronized with other devices (e.g., other small cell device 220). In some implementations, when small cell device 220 is unable to obtain the timing information form eNB 230, small cell device 220 may automatically obtain the timing information from another small cell device 220 in the vicinity.

eNB 230 may include one or more network devices that receives, processes, and/or transmits traffic destined for and/or received from small cell device 220 and/or user device 210 (e.g., via an air interface). eNB 230 may include one or more functionalities, such as radio resource management, mobility management, encryption, etc. In some implementations, eNB 230 may establish a D2D connection with another device, such as small cell device 220. Additionally, eNB 230 may periodically broadcast timing information throughout a coverage area of eNB 230 in accordance with a particular standard such as the 3GPP standard.

OAM server 240 may include one or more computing devices, such as a server device or a collection of server devices, capable of enabling remote monitoring and management of RANs of the wireless telecommunications network. For instance, OAM serer 240 may monitor the operational status of eNB 230 and determine if/when eNB 230 experiences technical difficulties. In some implementations, a technician operating OAM server 240 may be capable of troubleshooting or providing other types of technical support to eNB 230.

SGW 250 may aggregate traffic received from one or more eNBs 220 and may send the aggregated traffic to an external network or device via PGW 260. Additionally, SGW 250 may aggregate traffic received from one or more PGWs 260 and may send the aggregated traffic to one or more eNBs 230. SGW 250 may operate as an anchor for the user plane during inter-eNB handovers and as an anchor for mobility between different telecommunication networks. PGW 260 may include one or more network devices that may aggregate traffic received from one or more SGWs 250, and may send the aggregated traffic to an external network. PGW 260 may also, or alternatively, receive traffic from the external network and may send the traffic toward user device 210 (via SGW 250 and/or eNB 230).

MME 270 may include one or more computation and communication devices that act as a control node for eNB 230 and/or other devices that provide the air interface for the wireless telecommunications network. For example, MME 270 may perform operations to register user device 210 with the wireless telecommunications network, to establish bearer channels (e.g., traffic flows) associated with a session with user device 210, to hand off user device 210 to a different eNB, MME, or another network, and/or to perform other operations. MME 270 may perform policing operations on traffic destined for and/or received from user device 210.

HSS 280 may include one or more devices that may manage, update, and/or store, in a memory associated with HSS 280, profile information associated with a subscriber (e.g., a subscriber associated with user device 210). The profile information may identify applications and/or services that are permitted for and/or accessible by the subscriber; a Mobile Directory Number (MDN) associated with the subscriber; bandwidth or data rate thresholds associated with the applications and/or services; and/or other information. The subscriber may be associated with user device 210. Additionally, or alternatively, HSS 280 may perform authentication, authorization, and/or accounting operations associated with the subscriber and/or a communication session with user device 210.

PCRF 290 may receive information regarding policies and/or subscriptions from one or more sources, such as subscriber databases and/or from one or more users. PCRF 290 may provide these policies to PGW 260 or another device so that the policies can be enforced. As depicted, in some implementations, PCRF 290 may communicate with PGW 260 to ensure that charging policies are properly applied to locally routed sessions within the telecommunications network. For instance, after a locally routed session is terminated, PGW 260 may collect charging information regarding the session and provide the charging information to PCRF 290 for enforcement.

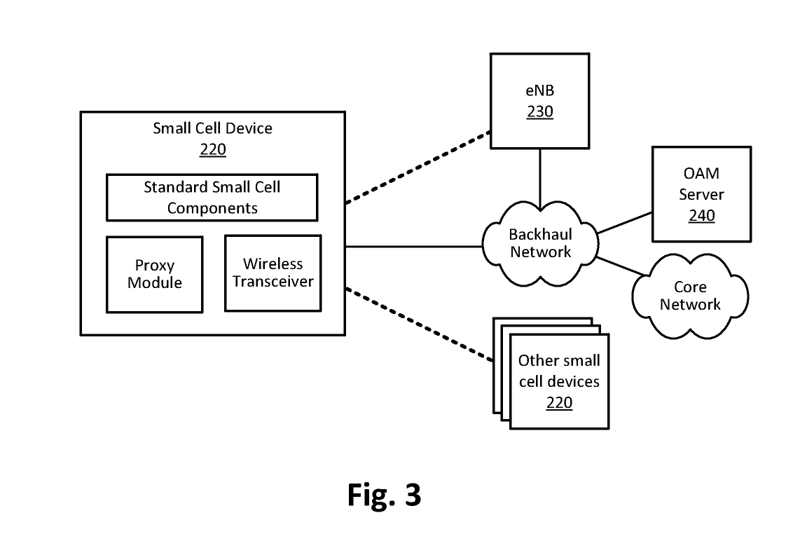

FIG. 3 is a diagram of an example of components of small cell device 220. As shown, small cell device 220 may include standard small cell components, a wireless transceiver, and a proxy module. The standard small cell components may include hardware and/or software components that enable small cell device 220 to function as a small cell device under normal operating conditions (e.g., provide wireless connectivity to user devices 210, implement network management and security policies, relay information between user devices 210 and another network (e.g., the Internet), etc.).

The wireless transceiver may be capable of receiving information from eNB 230. For example, the wireless transceiver may include a wireless transceiver found in user device 210. In some implementations, the wireless transceiver may also be capable of sending and receiving information from other small cell devices 220, which may include a D2D connection with the other small cell devices 220. A D2D connection, as used, herein, may refer to D2D Proximity Services (ProSe), as defined in the 3rd Generation Partnership Project (3GPP) technical specifications, such as in “3GPP TR 22.803, Technical Specification Group Services and Systems Aspects; Feasibility study for Proximity Services (ProSe) (Release 12)” (available at www.3gpp.org).

The proxy module may include hardware and software capable of identifying timing information from a signal broadcasted by eNB 230. In some implementations, the proxy module may provide the timing information to the standard small cell components, and the standard small cell components may set an internal clock of small cell device 220 based on the timing information. In some implementations, the standard small cell component may include an interface for receiving timing information from another source, such as a GPS server. In such implementations, the proxy module may convert, format, etc., the timing information from eNB 230 in accordance with what is anticipated by the standard small cell components. Additionally, the proxy module may include information and instructions that enable small cell device 220 to discover other small cell devices in the area and/or establish a D2D connection with other small cell devices via a wireless interface (e.g., the wireless transceiver). As such, in some implementations, the proxy module and/or the wireless transceiver may be physically incorporated into the small cell device 220, while in other implementations, the proxy module and/or wireless transceiver may be separate devices that are attached to an existing hardware interface to enable the small cell device 220 to operate as described herein.

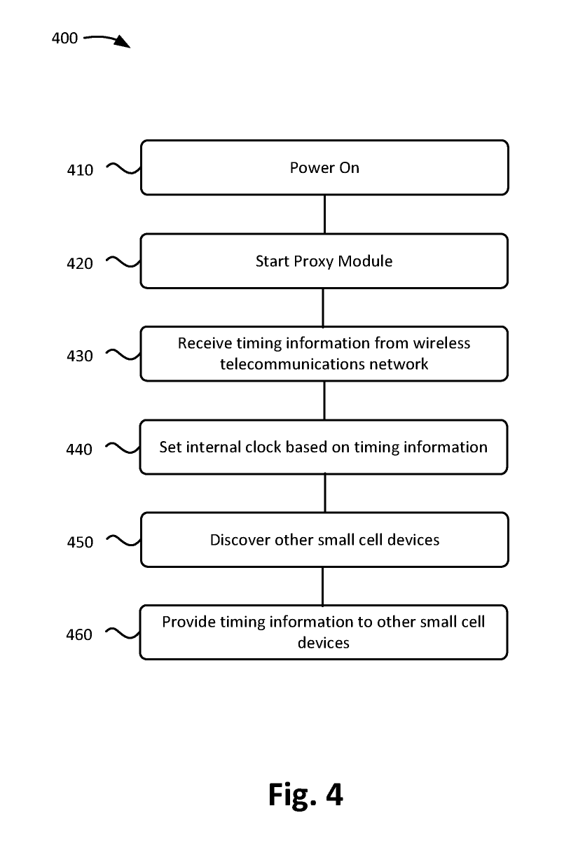

FIG. 4 is a flowchart diagram of an example process 400 for synchronizing small cell devices 220. Process 400 may be implemented by small cell device 220.

Process 400 may include powering on (block 410). For example, small cell device 220 may be powered on by connecting small cell device 220 to a power source, such as an outlet. In some implementations, powering on may trigger small cell device 220 to automatically perform the operations of process 400 (e.g., without commands or input from a network administrator). In some implementations, one or more other events may cause small cell device 220 to perform the operations of process 400. For instance, a system restart, a command from a network administrator, etc., may also cause small cell device 220 to perform the operations of process 400.

Process 400 may include starting a proxy module (block 420). For example, small cell device 220 may run a proxy module in response to powering on. As described above with reference to FIG. 3, the proxy module may include instructions and information that enable small cell device 220 to perform one or more of the operations described herein, such as automatically receiving timing information from eNB 230, converting the timing information to a format anticipated by the standard components of small cell deceive 220, discovering other small cell devices 220, etc.

Process 400 may include receiving timing information from a wireless telecommunications network (block 430). For example, the proxy module may receive timing information from eNB 230 via the wireless transceiver discussed above with reference to FIG. 3. In some implementations, the timing information may be passively received by the proxy module. For instance, the small cell device 220 may not need to connect or send a request to eNB 230 in order to receive the timing information. The small cell device 230 may receive the timing information as a natural consequence of being powered on. The timing information may periodically broadcasted by eNB 230 throughout the coverage area of eNB 230.

Process 400 may setting an internal clock based on the timing information (block 440). For example, the proxy module may convert the timing information received from eNB 230 to a format that is required by the standard components of small cell device 220, and then may provide the timing information to a standard small cell component responsible for setting and maintaining an internal clock. The standard small cell component receiving the timing information may use the timing information to set the internal clock.

For example, in one implementation, when small cell device 220 includes an interface that is designed to receive timing information that is formatted as GPS signaling, the proxy module may format the received timing information to a signaling format that is compatible with the GPS interface of the standard small cell components. In particular, with respect to FIG. 3, the proxy module may be connected, via a physical cable, to a GPS interface of the standard small cell components of small cell device 220. The proxy module may use the GPS interface of the standard small cell components of small cell device 220 to provide the timing information to small cell device 220.

Process 400 may include discovering other small cell devices (block 450). For example, small cell device 220 may broadcast a device discovery signal used for discovering other wireless devices (e.g., other small cell devices 220) within the broadcast range of small cell device 220. Other small cell devices 220 that receive the device discovery signal may respond so that each small cell device 220 is aware of the other. In some implementations, the small cell devices 220 may automatically exchange identifiers, negotiate encryption keys establish a wireless connection with one another. In some implementations, the wireless connection may include a D2D connection.

Process 400 may include providing the timing information to other small cell devices (block 460). For instance, small cell device 220 may broadcast timing information throughout a coverage area of small cell device 220. In such implementations, small cell devices that are outside the coverage area of eNB 230 but inside the coverage area of small cell device 220 may receive timing information from small cell device 220. In response to receiving the timing information, the small cell devices 220 may perform one or more of the operations described above, such as setting an internal clock, discovering other small cell devices, establishing connections with other small cell devices 220, etc.

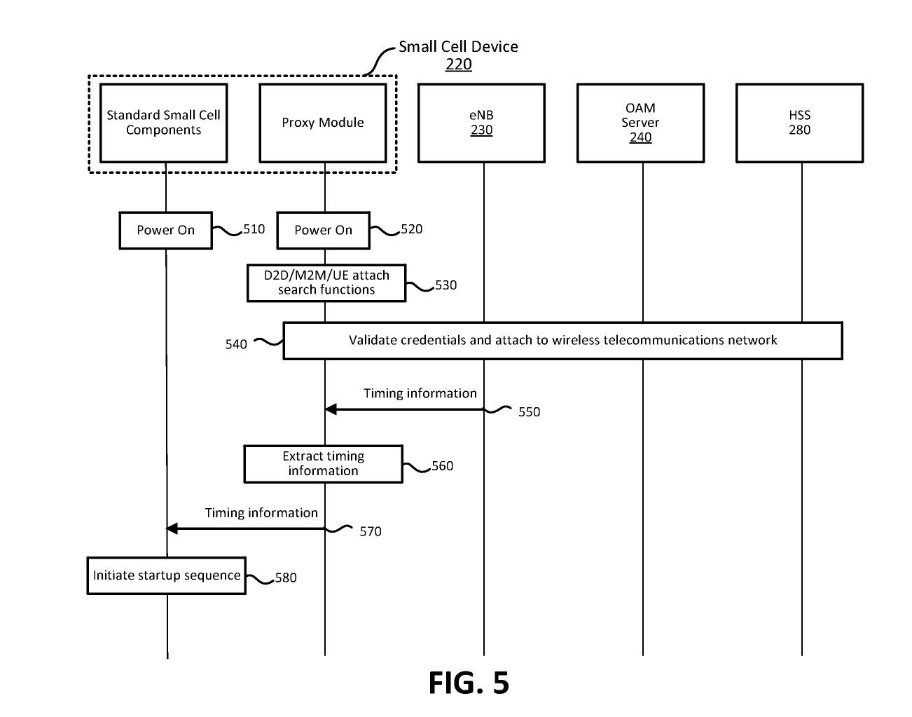

FIG. 5 is a sequence flow diagram of an example implementation for setting an internal clock of small cell device 220. As shown, FIG. 5 includes small cell device 220, eNB 230, OAM server 240, and HSS 280. Small cell device 220 may include standard small cell components and a proxy module. The standard small cell components may correspond to the standard components described above with reference to FIG. 3. Similarly, the proxy module may correspond to the proxy module and wireless transceiver that are also discussed above with reference to FIG. 3.

As depicted, small cell device 220 may be powered on (blocks 510 and 520). The proxy module may perform search functions for D2D connections, machine-to-machine (M2M) connections, and/or a UE attach type connection (block 530). For instance, small cell device 210 may broadcast a device discovery signal in search of other devices that small cell device 210 may communicate with, whether it be via a D2D connection or a M2M connection. In some implementations, small cell device 210 may listen for a device discovery signal from another device. Additionally, small cell device 210 may search for signals being broadcasted by eNB 230 and may perform a use equipment (UE) attachment procedure with eNB 230. Small cell device 220 may initiate a validation (or authentication) procedure with respect to the wireless telecommunications network of eNB 230 (block 540).

At some point, small cell device 220 may receive timing information from eNB 230 (line 550). In some implementations, small cell device 220 may not be required to request the timing information as eNB 230 may periodically transmit timing information. In some implementations, the timing information may also, or alternatively, be received by small cell device 220 in response to a request for the timing information from small cell device 220.

Small cell device 220 may extract the timing information received from eNB 230 (block 560) and may communicate the timing information to the standard small cell components portion of small cell device 220 (line 570). Small cell device 220 may execute a startup sequence to initialize small cell device 220. The startup sequence may include using the timing information to synchronize an internal clock of small cell device 220. Accordingly, small cell device 220 may receiving timing information directly from a wireless telecommunications network via a connection with eNB 230.

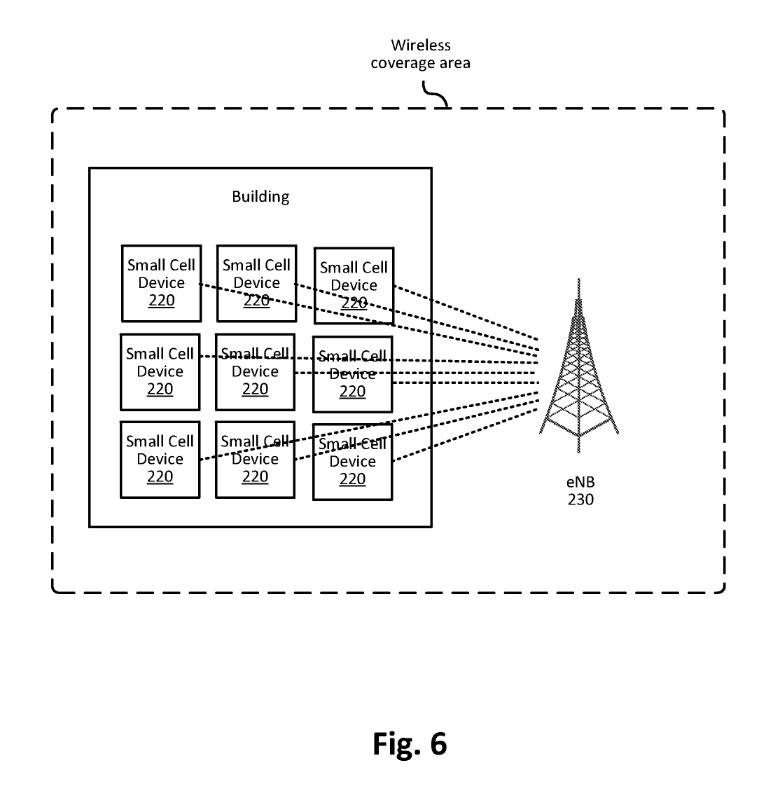

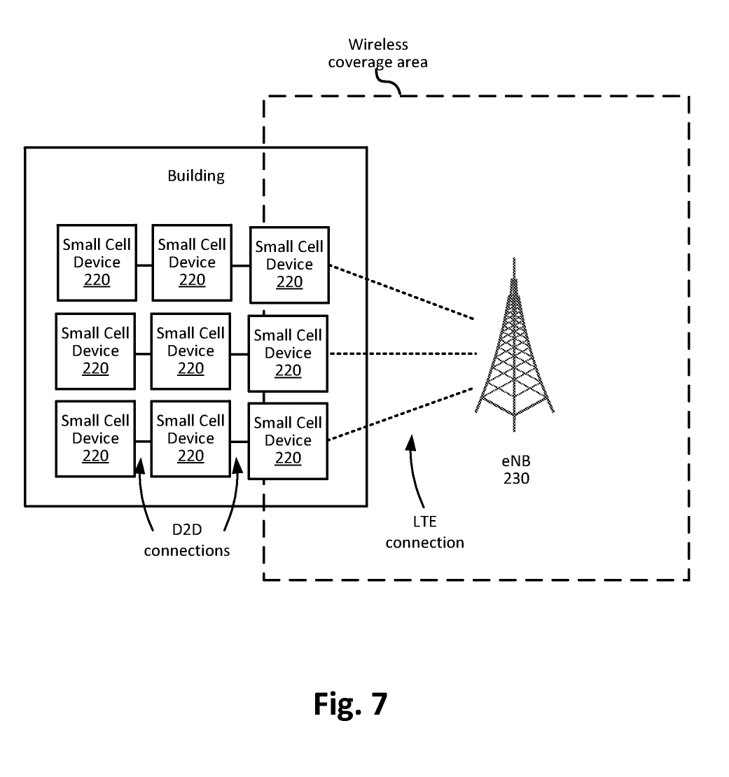

FIGS. 6 and 7 are diagrams of example implementations for a network of small cell devices 220. As shown in FIG. 6, a building may include multiple small cell devices 220. All of the small cell devices may be within the coverage area of eNB 230. Small cell devices 220 may automatically receive timing information that is periodically broadcasted by eNB 230 and may become synchronized with one another by setting an internal clock of each small cell device 220 according to the timing information. Small cell devices 220 may also discover one another automatically by broadcasting a device discovery signal and may establish connections (e.g., a D2D connections) with one another to form a network of small cell devices 220.

Referring now to FIG. 7, some of small cell devices 220 in the building may be out of the coverage area of eNB 230. In such a scenario, small cell devices 220 within the coverage area may automatically receive timing information broadcasted by the eNB 220 and may set an internal clock according to the timing information in order to become synchronized. The synchronized small cell devices 220 may broadcast device discovery signals in search for other small cell devices 220 in the building. Upon discovering another small cell device 220, one of the synchronized small cell devices 220 may establish a D2D connection with the newly discovered small cell device 220 and may provide the new small cell device 220 timing information that may be used by the new small cell device 220 to become synchronized. The new small cell device 220 may, in turn, begin broadcasting a device discover in order to discover and become synchronized with other small cell devices 220 in the building.

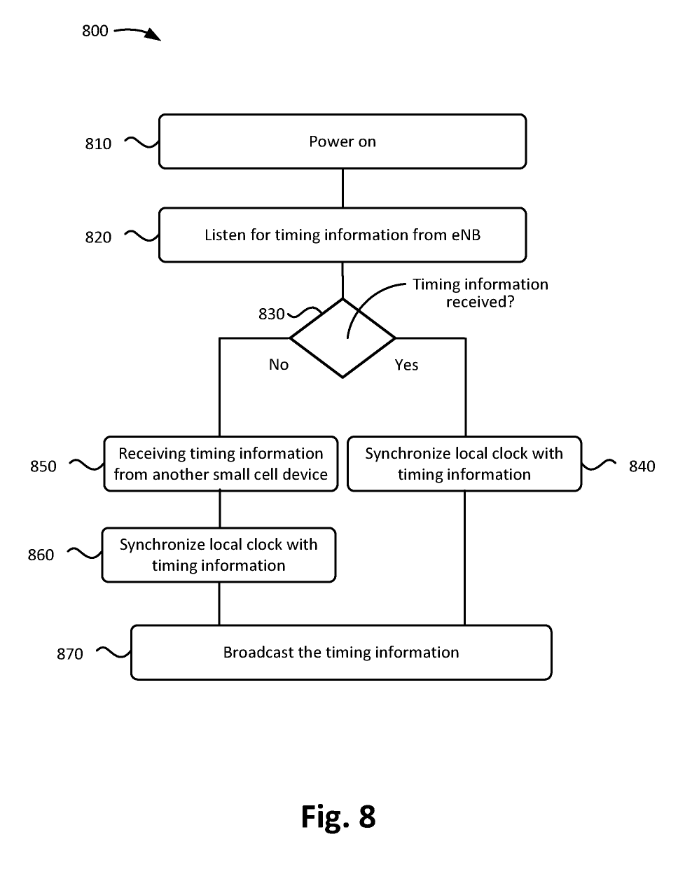

FIG. 8 is a flowchart diagram of an example process 800 for synchronizing an internal clock of small cell device 220. Process 800 may be implemented by small cell device 220.

As shown, process 800 may include powering on (block 810). For example, small cell device 220 may be powered on by connecting small cell device 220 to a power source, such as an electrical outlet. In some implementations, powering on may trigger small cell device 220 to automatically perform the operations of process 800. In some implementations, one or more other events or operations may cause small cell device 220 to perform the operations of process 800. For instance, a restart operation, a system reset operation, a command from a user device 210 of a network administrator, etc., may also cause small cell device 220 to perform the operations of process 800.

Process 800 may include listening for timing information from eNB 230 (block 820). For example, small cell device 220 may be capable of passively detecting a radio signal, from eNB 230, which includes timing information. In some implementations, this may accomplished via the proxy module and wireless transceiver discussed above with reference to FIG. 3. When the timing information is received (block 830—Yes), process 800 may include synchronizing a local clock of small cell device 220 with the timing information (block 840). When the timing information is not received (block 830—No), process 800 may include receiving timing information from another small cell device 220 (block 860). For example, when a small cell device 220 within the coverage area of eNB 230 receives timing information from eNB 230, the small cell device 220 may communicate the timing information so that small cell devices 220 outside of the coverage area of eNB 230 may still be able to receiving the timing information and be synchronized. As such, as depicted, process 800 may include synchronizing a local clock with the timing information (received from another small cell device 220) (block 860), and broadcasting the timing information (block 870).

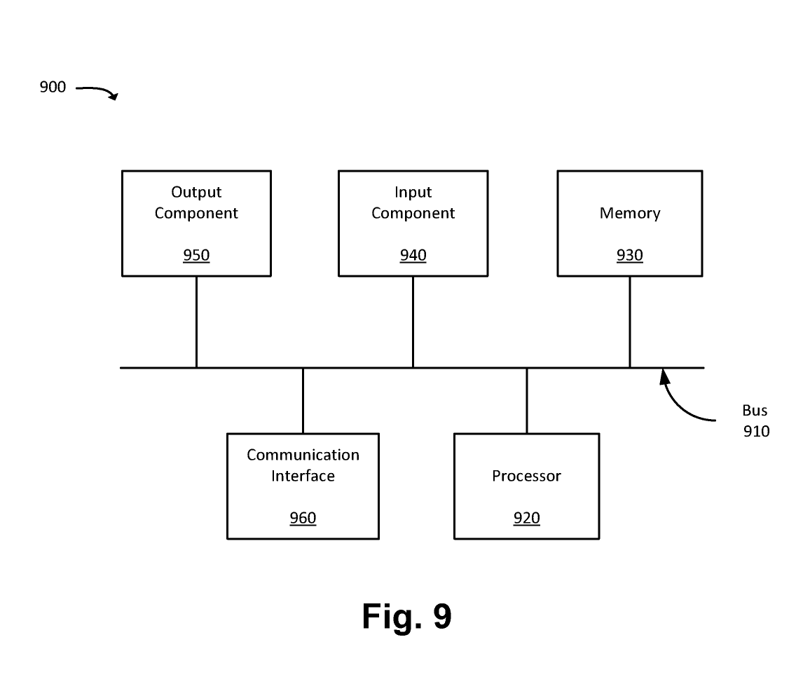

FIG. 9 is a diagram of example components of a device 900. Each of the devices illustrated in FIGS. 1A-1D, 2, 3, and 5-7 may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (LEDs), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (IR) receiver, a cellular radio, a Bluetooth radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with regard to FIGS. 4, 5, and 8, the order of the blocks may be modified in other implementations. Further, non-dependent blocks may be performed in parallel. Similarly, while series of communications have been described with regard to several of the Figures provided herein, the order or nature of the communications may potentially be modified in other implementations.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an application-specific integrated circuit (ASIC) or a field-programmable gate array (FPGA), or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method performed by a small cell device, comprising:
receiving, by the small cell device, timing information broadcasted by a base station of a cellular telecommunications network;
synchronizing, by the small cell device, an internal clock, of the small cell device, with the timing information;
performing device-to-device (D2D) discovery, by the small cell device, to discover other small cell devices in a vicinity of the small cell device;
establishing, by the small cell device, a wireless D2D connection with the at least one of the discovered small cell devices; and
communicating, by the small cell device and using the D2D connection, the timing information to the at least one of the discovered small cell devices.

2. The method of claim 1, further comprising:
converting the timing information from a first format to a second format prior to synchronizing the internal clock.

3. The method of claim 2, wherein the second format includes a global positioning system (GPS) timing information.

4. The method of claim 1, wherein the communicating of the timing information is performed by communicating the wireless signal.

5. The method of claim 1, wherein the receiving of the timing information is automatically performed in response to the small cell device powering on.

6. The method of claim 1, wherein the receiving of the timing information includes passively detecting a signal from the base station without establishing a connection with the base station.

7. The method of claim 1, wherein the communicating of the timing information enables the at least one of the discovered small cell devices to become synchronized with the small cell device.

8. The method of claim 1, wherein the base station includes an enhanced Node B (eNB) of a Long-Term Evolution (LTE) wireless communications network.

9. The method of claim 1, further comprising:
receiving a device discovery signal from an additional small cell device; and
automatically establishing a connection with the additional small cell device in response to the device discovery signal.

10. A small cell device, comprising:
a non-transitory memory device storing a plurality of processor-executable instructions; and
a processor configured to execute the processor-executable instructions, wherein executing the processor-executable instructions causes the processor to:
receive timing information broadcasted by a base station of a cellular telecommunications network;
synchronize an internal clock, of the small cell device, with the timing information;
perform device-to-device (D2D) discovery to discover other small cell devices in a vicinity of the small cell device;
establish a wireless D2D connection with the at least one of the discovered small cell devices; and
communicate, using the D2D connection, the timing information to the at least one of the discovered small cell devices.

11. The small cell device of claim 10, wherein the processor-executable instructions cause the processor to:
convert the timing information from a first format to a second format prior to synchronizing the internal clock.

12. The small cell device of claim 11, wherein the second format includes a global positioning system (GPS) timing information.

13. The small cell device of claim 10, wherein, to communicate the timing information, the processor-executable instructions cause the processor to: communicate the timing information via a wireless signal.

14. The small cell device of claim 10, wherein, to receive the timing information, the processor-executable instructions cause the processor to: passively detect a signal from the base station without establishing a connection with the base station

15. The small cell device of claim 10, wherein the base station includes an enhanced Node B (eNB) of a Long-Term Evolution (LTE) wireless communications network.

16. The small cell device of claim 10, wherein the processor-executable instructions cause the processor to:
receive a device discovery signal from an additional small cell device; and
automatically establish a connection with the additional small cell device in response to the device discovery signal.

17. A small cell device comprising logic to:
power on in response to being connected to a power supply;
listen for a wireless signal, from a base station, that includes timing information;
when the wireless signal is received within a preselected duration,
synchronize an internal clock based on the timing information from the base station; and
when the wireless signal is not received within the preselected duration;
perform device-to-device (D2D) discovery to discover other small cell devices within a coverage area of the small cell device,
discover at least one other small cell device,
receive the timing information from the other small cell device, and
synchronize the internal clock based on the timing information from the at least one other small cell device.

18. The small cell device of claim 17, wherein the small cell device comprises logic to:
automatically establish the D2D connection with the at least one other small cell device upon discovery of the at least one other small cell device.

19. The small cell device of claim 18, wherein the small cell device comprises logic to: receive the timing information via the D2D connection with the at least one other small cell device.

20. The small cell device of claim 17, wherein the small cell device comprises logic to:
automatically discover an additional small cell device;
automatically establish a D2D connection with the additional small cell device; and
automatically communicate the timing information to the additional small cell device.
